(19) United States
(12) Patent Application Publication
(10) Pub. No.: US 2019/0322879 A1
(43) Pub. Date: Oct. 24, 2019

(54) Aqueous Polyurethane Microgel Dispersion

(71) Applicant: Encapsys, LLC, Appleton, WI (US)

(72) Inventor: Hanwei Zhang, Lena, WI (US)

(73) Assignee: Encapsys, LLC, Appleton, WI (US)

(21) Appl. No.: 16/373,748

(22) Filed: Apr. 3, 2019

Related U.S. Application Data
(60) Provisional application No. 62/659,211, filed on Apr. 18, 2018.

(51) Int. Cl. C09D 5/26; C08J 3/075; C08J 3/16; C08G 18/76; C09D 175/04

(52) U.S. Cl. CPC C09D 5/26; C08J 3/075; C09D 175/04; C08G 18/7671; C08J 3/16

(57) ABSTRACT

The invention describes a method of forming a stable aqueous polyurethane microgel dispersion comprising preparing an oil phase comprising a gel-forming polyol and an isocyanate in approximately stoichiometric proportion by blending the polyol and isocyanate for a time, less than the gel time of the polyol and isocyanate, thereby forming a homogeneous flowable liquid mixture; providing a water phase comprising a surfactant dispersed in water; combining the water phase with the oil phase flowable liquid mixture and subjecting the combined water and oil phases to high shear agitation to form an aqueous emulsion of micro-size droplets of the oil phase flowable mixture in water; and agitating the emulsion for a time sufficient for the micro-size droplets to polymerize, forming a stable aqueous suspension of solid polyurethane micro-size gel particles. The resultant aqueous suspension of solid polyurethane micro-sized gel particles is substantially free of isocyanate monomer, and is a shelf-stable aqueous suspension of solid polyurethane micro-size gel particles in water. Optionally, a benefit agent is incorporated during or after formation of the microgel dispersion.

### FIELD OF THE INVENTION

This invention relates to polyurethane gel dispersion, processes of making, coatings and coated articles produced by such processes, and more particularly a process for forming an aqueous polyurethane microgel dispersion.

### DESCRIPTION OF THE RELATED ART

Polyurethanes are useful in a variety of processes including interfacial polymerization which is a process wherein a microcapsule wall such as polyamide, an epoxy resin, a polyurethane, a polyurea or the like is formed at an interface between two phases. In Riecke, U.S. Pat. No. 4,622,267 an interfacial polymerization technique is disclosed for preparation of microcapsule wherein the core material is initially dissolved in a solvent and an aliphatic diisocyanate soluble in the solvent mixture is added. Subsequently, a nonsolvent for the aliphatic diisocyanate is added until the turbidity point is just barely reached. This organic phase is then emulsified in an aqueous solution, and a reactive amine is added to the aqueous phase. The amine diffuses to the interface, where it reacts with the diisocyanate to form polymeric polyurethane shells. A similar technique, used to encapsulate salts which are sparingly soluble in water in polyurethane shells, is disclosed in Greiner et al., U.S. Pat. No. 4,547,429.

Polyurethane coatings are often fashioned from reaction of aliphatic poly- or diisocyanates with diols or polyols. Dounis et al., U.S. Pat. No. 8,906,975 describes polyurethane foams formed from methylene diphenyl diisocyanate reacted with a polyol that is a polyol ether. A method of forming polyurethanes in the form of dry particulates is described in Irie et al., U.S. Pat. No. 5,250,640.

U.S. Patent Publication 2008/0103251 describes water dissipatable polyurethane dispersions prepared from an aliphatic isocyanate and an alkylene glycol or other monomer with isocyanate-reactive groups. The reaction product is further end capped with a monofunctional group such as an azide, thiol, alcohol or amine.

U.S. 2013/0224367 describes polyurethane particles obtained by spray drying an aqueous dispersion of isocyanate-terminated urethane prepolymers.

U.S. 2003/0088019 describes embedding phase change material into a polyurethane gel. The liquid phase change material is incorporated into a polyol component, then further processed into a polyol component, then further processed into articles such as polyurethane gel materials.

One of the applications of polyurethane gel is in manufacture of “cooling gel” on bedding products such as pillows or mattresses. This “cooling gel” is capable of providing a cooling effect by improving thermal conductivity. US 20160073800A1 describes gel molded pillows and method of producing the same. A gel system is described which is comprised of a polyurethane-based gel applied on both sides of a pillow, which helps to improve the thermal conductivity, and is capable of absorbing an amount of heat and providing a cooling effect.

One problem in the art of a “cooling gel” system has been that polyol and isocyanate monomer blends have a relative limited operation time, and the gel-forming mixtures are also highly viscous and sticky, which means they can only effectively be applied to small sized products, and not to large size products such as textiles or fabrics. Another problem is the safety consideration due to the isocyanate monomers during application. Another problem is that water-based materials such as encapsulated phase change capsules, binders, softeners, etc. cannot be applied with such “cooling gel” systems due to the reaction of isocyanate with water. Forming a chemically and physically stable aqueous suspension of solid polyurethane micro-size particles, with the suspension able to combine with various water-based materials and form a further curable coating, when the suspension is applied to various substrates and cured to form a temperature moderating (or “cooling gel”) coating, would be an advance in the art.

### DESCRIPTION OF THE DRAWINGS

FIG. 1 is a microscope photograph of a polyurethane microgel dispersion according to Example 1.

FIG. 2A depicts a microgel dispersion according to Example 2. FIG. 2B is the resulting polyurethane gel film formed when the microgel dispersion, according to Example, 2 is dried.

FIG. 3 illustrated the thermal conductivity of a cured microgel dispersion, according to Example, 3 applied to foam.

FIG. 4 illustrated the thermal conductivity of a cured microgel dispersion, according to Example 4, applied to fabric.

FIG. 5 illustrated the thermal conductivity of a cured microgel dispersion with EnFinit® microencapsulated phase change slurry, according to Example 5, applied to fabric.

### DESCRIPTION OF THE INVENTION

The present invention describes a composition and method of forming a stable aqueous polyurethane microgel dispersion comprising i) preparing an oil phase comprising a gel-forming polyol and an isocyanate in approximately stoichiometric proportion by blending the polyol and isocyanate for a time, less than the gel time of the polyol and isocyanate, thereby forming a homogeneous flowable liquid mixture, ii) providing a water phase comprising a surfactant dispersed in water, iii) combining the water phase with the oil phase flowable liquid mixture and subjecting the combined water and oil phases to high shear agitation to form an aqueous emulsion of micro-size droplets of the oil phase flowable mixture in water, and iv) agitating the emulsion for a time sufficient to allow for the micro-size droplets to polymerize, forming a stable aqueous suspension of solid polyurethane micro-size gel particles.

The polyols and isocyanates useful in the invention are reactive gel-forming polyol and isocyanate monomers. The polyol and isocyanate monomers have a gel time. When mixed together, preferably in stoichiometric proportion, the reactive groups of the constituent monomers react to form polyurethane tying up the constituent monomers so as preferably not to leave free residual monomer. A homogeneous flowable mixture is formed by blending the polyol and isocyanate monomers for less than the gel time.

In preparing the oil phase, the polyol is blended with the isocyanate for a relatively short period of time, shorter than the gel time of the blend or what is commonly understood as pot life. The blend forms a homogeneous flowable liquid mixture.

For the water phase, a surfactant is blended with water to form a homogeneous aqueous solution. Preferably the surfactant is a sulfate, free of hydroxy or amine groups. An advantageous surfactant is sodium laureth sulfate.

In one aspect, the polyol is preferably a hydrophobic, water-dispersible, or slightly water-soluble polyol having a viscosity less than 3000 cps (centipoise), or even less than 1000 cps. A useful isocyanate is methylene diphenyl diisocyanate or its prepolymer. A surfactant can be included, preferably a sulfate substantially free of hydroxy or amine groups such as sodium laureth sulfate.

The polyol is water dispersible or slightly water soluble. Desirably the polyol has a solubility below about 10 g/ml at 25° C., or even below 5 g/ml, or even less than 2 g/ml or 1 g/ml, or even less than 0.1 g/ml.

The polyol and isocyanate blend of the invention has a gel time or pot life of from 1 to 60 minutes, preferably 5 to 20 minutes. The mixing time should be selected to be shorter than the gel time or pot life. By limiting the mixing time in the blending step of preparing the oil phase, there is no significant polyurethane gel or prepolymer formation during the oil phase preparation.

In the process of the invention, the polyol and isocyanate blend can later be substantially reacted by in-situ polymerization after aqueous emulsion is formed. The aqueous suspension of micro-size polyurethane gel particles formed has substantially no free isocyanate monomer. The size of the micro-size polyurethane gel particle is on average less than 1000 microns on a volume weighted basis, preferably less than 100 microns, more preferably less than 10 microns

The composition and process of the invention is flexible in that a benefit agent such as an essential oil, a fragrance, a phase change material and the like can optionally be added in any of steps i) through iv), or after step iv) recited above, with addition after step iv) being preferred.

Step i) of the process mainly achieves mixing of the polyol and isocyanate. The mixing time in step i) must be less than the gel time. The gelling reaction primarily takes place after the emulsion is formed in step iv).

After step iv) the suspension or dispersion can be applied as a coating to a substrate such as foam or textile or other surfaces. Optionally binders, adhesives or rheology modifiers, or other common additives such as leveling agents, UV blockers, pigments, or even additional or other benefit agents, can be added to the dispersion to form a workable coating. After the suspension is applied as a coating, the microgel formation reaction is largely complete. Hardening or curing of the applied coating is accomplished through evaporation and/or heating. During evaporation the microgel particles concentrate and stick together, adhere or coalesce to form a polyurethane layer or film. The resultant film becomes a gel coating. By including a phase change material, a cooling gel is formed. The gel coating is transparent or can be optionally colored or opacified with dyes or pigments.

Depending on the intended end use application, the one or more benefit agents, optionally, may be microencapsulated. Combinations with encapsulated and unencapsulated benefit agents may also be employed. Various methods for microcapsule manufacture are available to the skilled artisan, including Zhang et al., U.S. Pat. No. 9,937,477; Schwantes, U.S. Pat. No. 6,592,990; Jahns et al., U.S. Pat. Nos. 5,596,051 and 5,292,835; Matson, U.S. Pat. No. 3,516,941; Brown, U.S. Pat. No. 4,552,881; Foris, U.S. Pat. Nos. 4,001,140 and 4,089,802; and Smets et al., U.S. Pat. No. 8,067,35. Each patent described throughout this application is incorporated herein by reference to the extent each provides guidance regarding microencapsulation processes and materials. In the examples herein, commercially available microcapsules were used, available as EnFinit® PCM28 from Encapsys, LLC, Appleton, Wis.

The invention is useful with one or more optional benefit agents. Benefit agents depending on the intended end use application, can encompass various materials including phase change materials such as for temperature moderation or cooling, pigments, colorants, perfumes; fragrances, essential oils, brighteners, insect repellants, silicones, waxes, softening agents, dyes, chromogens, cooling agents, attractants such as pheromones, repellants, bactericides; mold inhibitors, pigments; pharmaceuticals, fertilizers, herbicides, and various mixtures thereof.

The term “isocyanate as used herein includes, by way of illustration and not limitation, single isomer such as 2,4-toluene diisocyanate, hexamethylene diisocyanate and 1,5-napthalene diisocyanate; single isomers or mixtures such as tertiary aliphatic diisocyanate; mixtures such as toluene diisocyanate and methylene diisocyanate; conformer mixtures such as isophorone diisocyanate and 4,4′-methylene dicylohexyl diisocyanate. Isocyanate is also intended to encompass polymeric methylene diphenyl diisocyanate. Biurets and trimerized diisocyanates are also intended.

The isocyanate can comprise isocyanates having two or more isocyanate groups per molecule. The isocyanates for purposes hereof include polyisocyanates and can be selected from aliphatic, cycloaliphatic and araliphatic polyisocyanates, as well as aromatic polyisocyanates and heterocyclic polyisocyanates, such as toluene diisocyanate or diphenylmethane diisocyanate (MDI). Blends of isocyanates or polyisocyanates can also be employed.

Polymeric MDI, useful in the invention, may contain at least 70% by weight of pure MDI (4,4′-monomer or monomer mixture) or up to 30% by weight of polymeric MDI containing from 25 to 65% by weight of diisocyanates, the remainder being largely polymethylene polyphenylene polyisocyanates having isocyanate functionalities greater than 2. Mixtures may also be used of pure MDI and polymeric MDI compositions containing higher proportions (up to 100%) of higher functionality polyisocyanates.

Specific examples of useful isocyanates are ethylene diisocyanate, tetramethylene-1,4-diisocyanate, hexamethylene-1,6-diisocyanate, dodecane-1,12-diisocyanate, cyclobutane-1,3-diisocyanate, cyclohexane-1,3-diisocyanate, cyclohexane-1,4-diisocyanate and mixtures of these monomers; 1-isocyanato-3,3,5-trimethyl-5-isocyanatomethylcyclohexane, hexahydrotoluylene-2,4-diisocyanate and hexahydrotoluylene-2,6-diisocyanate, and any desired mixtures of these isomers; hexahydrophenylene-1,3-diisocyanate and/or hexahydrophenylene-1,4-diisocyanate, perhydro-diphenyl methane 2,4′-diisocyanate and/or perhydro-diphenyl methane-4,4′-diisocyanate, phenylene-1,3-diisocyanate, phenylene-1,4-diisocyanate, toluylene-2,4-diisocyanate and toluylene-2,6-diisocyanate, and mixtures of these monomers; diphenylmethane-2,4′-diisocyanate and/or diphenylmethane-4,4′-diisocyanate and naphthylene-1,5-diisocyanate, isophorone diisocyanate, triphenyl-methane-4,4′,4″-triisocyanate; polyphenyl-polymethylene polyisocyanates, m- and p-isocyanatophenylsulphonyl isocyanates, polyisocyanates having carbodiimide groups, norbornane diisocyanates, polyisocyanates having allophanate groups, polyisocyanates having isocyanurate or urethane groups, polyisocyanates which have acylated urea groups, polyisocyanates having biuret groups, polyisocyanates having ester groups and polyisocyanates which contain polymeric fatty acid esters, and mixtures of any of the foregoing.

Toluene-2,4-diisocyanate and toluene 1,6-diisocyanate, polyphenyl-polymethylene polyisocyanates and polyisocyanates having carbodiimide groups, urethane groups, allophanate groups, isocyanate groups, urea groups or biuret groups are also useful isocyanates, alone or as part of mixtures.

Biuretized or trimerized hexamethylene-1,6-diisocyanate, and addition products onto short-chain or long-chain polyols containing NCO groups, as well as mixtures of these isocyanates, are also useful isocyanates.

The content of diisocyanate and/or polyisocyanate in the gel-forming mixtures according to the present invention is 1 to 50 mole %, preferably 1 to 45 mole %, relative to the total mole ratio of isocyanate and hydroxy groups, so as not to leave free residual isocyanate monomer.

The gel-formation reaction, which in itself proceeds slowly, can be accelerated by the addition of catalysts. Catalysts, however, are optional. Suitable catalysts are those known to accelerate the reaction between hydroxyl groups and isocyanate groups.

Suitable catalysts include various organometallic catalysts, such as organotin, organomercury and organolead. Examples of suitable catalysts include stannous octoate, dibutylin dilaurate, dibutylin mercaptide, phenylmercuric propionate, lead octoate, potassium acetate/octoate, qauternary ammonium formate and ferric acetylacetonate. Suitable catalysts also include, tertiary amines, such as triethylamine, tributylamine, N-methylmorpholine, N-ethyl-morpholine, N-(coconut alkyl)-morpholine, N,N,N′,N′-tetramethyl-ethylene diamine, 1,4-diaza-bicyclo-(2,2,2)-octane, N-methyl-N′-dimethylaminoethyl-piperazine, N,N-dimethyl-benzylamine, bis-(N,N-diethylaminoethyl) adipate, N,N-dimethylbenzylamine, pentamethyldiethylenetriamine, N,N-dimethylcyclohexylamine, N,N,N′,N′-tetramethyl-1,3-butanediamine, N,N-dimethyl-p-phenylethylamine, 1,2-dimethylimidazole, and 2-methylimidazole, N,N-dimethylethanolamine, N,N-dimethylcyclohexylamine, bis(N,N-dimethylaminoethyl)ether, N,N,N′,N′,N″-pentamethyldiehtylenetriamine, 1,4-diazabicyclo[2.2.2]octane, triethylenediamine, 2-(2-dimethylaminoethoxy)-ethanol, 2-((2-dimethylaminoethoxy)ethyl methyl-amino)ethanol, 1-(bis(3-dimethylamino)-propyl)amino-2-propanol, N,N′,N″-tris(3-dimehtylamino-propyl)hexahydrotriazine, dimorpholinodiethylether, N,N,N′,N″,N″-pentamethyldipropylenetriamine and N,N′-diethylpiperazine. Mannich bases derived from secondary amines (such as dimethylamine), and aldehydes, or ketones (such as acetone, methyl ethyl ketone or cyclohexanone) and phenols (such as phenol, nonylphenol or bisphenol) are also optional as catalysts.

Suitable polyols in the invention are materials having two or more hydroxyl groups per molecule. The polyols should have multifunctional groups (greater than 2) in order to be able to react to from a cross-linked polyurethane type gel. Nonlimiting examples of such materials suitable for use in the compositions of the invention include polyalkylene ether polyols, thio esters, polyester polyols, polyhydroxy polyester amides, hydroxyl-containing polycaprolactones, hydroxy-containing acrylic copolymers, polyether polyols formed from the oxyalkylation of various polyols, for example, glycols such as ethylene glycol, 1,6-hexanediol, Bisphenol A and the like, or higher polyols such as trimethylolpropane, pentaerythritol, and the like. Polyester polyols also can be used. Polyols with higher functionality, such as formed by oxyalkylation of sorbitol or sucrose or other polysaccharides can also be used.

Useful polyols can also be selected from poly(oxytetramethylene) glycols, poly(oxyethylene) glycols, polypropylene glycols and reaction products of ethylene glycol with a mixture of propylene oxide and ethylene oxide.

In one embodiment the polyols can be linear, having a hydroxy value of 2000 or less.

The polyols useful in the invention are typically di- or polyhydroxyl compounds. The di- or polyols can be low molecular weight diols, triols or higher alcohols, low molecular weight amide containing polyols, or hydroxy containing acrylic copolymers.

Preferably the polyol is hydrophobic, water dispersible or a slightly water-soluble polyol, and in certain embodiments having a viscosity less than 1000 centipoise (cps).

The polyols can be either low or high molecular weight and in one embodiment have average hydroxyl values between 10 and 2000, or even between 50 and 1500, or even between 30 and 200.

The polyols can include low molecular weight diols, triols and higher alcohols and polymeric polyols including polyester polyols and polyether polyols. Examples include ethylene glycol; propylene glycol; 1,4-butanediol; 1,6-hexanediol; cycloaliphatic polyols such as 1,2-cyclohexanediol and cyclohexane dimethanol; trimethylol propane; glycerol; pentaerythritol and oxyalkylated glycerol.

Suitable classes of surfactants include, but are not restricted to, various alkyl sulfates, alkyl sulphonates, alkyl phosphonates, alkyl carboxylates. Suitable surfactants include one or more of various sulfates such as sulfates of ethoxylated phenols; alkali metal lauryl sulfates; alkali metal alkylbenzene sulfonates such as branched and linear sodium dodecylbenzene sulfonates. Suitable surfactants include anionic and nonionic fluorocarbon surfactants such as fluorinated alkyl esters and alkali metal perfluoroalkyl sulfonates. The surfactant can be selected from the group consisting of: potassium or sodium laureth sulfate, sodium lauroyl methyl isethionate, sodium lauryl isethionate, sodium cocoyl isethionate, sodium laureth-5 carboxylate, lauryl ether carboxylic acid, ammonium lauryl sulfate, sodium lauryl sulfate, potassium lauryl sulfate, potassium laureth sulfate, ammonium cocoyl sulfate, ammonium lauroyl sulfate, sodium cocoyl sulfate, sodium lauroyl sulfate, potassium cocoyl sulfate, sodium tridecyl benzene sulfonate, sodium dodecyl benzene sulfonate, sodium C14-16 olefin sulfonate, sodium caprylic sulfate, sodium capric sulfate, sodium oleic sulfate, sodium stearyl sulfate, sodium myreth sulfate, sodium dodecanesulfate, sodium monododecyl sulfate and mixtures thereof.

The amount of the surfactant may range from 0.01 to 30% by weight, preferably from 1 to 25% by weight, and more preferably from 1 to 10% by weight, relative to the total weight of the composition.

### EXAMPLES

In the following examples, the chemicals correspond to the following materials.

| Trade Name | Company/City | Material | Weight (%) |
|---|---|---|---|
| Hyperlast LU 1081 | Dow Chemical Company | polyol | 80 |
| | Corp, Midland, MI | | |
| Hyperlast LP 5613 | Dow Chemical Company | methylene diphenyl | 20 |
| | Corp, Midland, MI | diisocyanate | |
| EnFinit ® PCM28 | Encapsys, LLC | Phase change | |
| | Appleton, WI | microcapsule | |
| Impranil ™ DLP-R | Covestro | Aliphatic polyester | |
| | Leverkusen, Germany | polyurethane binder | |
| Acrysol ™ RM-12W | Dow Chemical Company | Rheology modifier, | |
| | Corp., Midland, MI | solvent (ethylene oxide | |
| | | block copolymer) | |

### Test Methods

### Thermal Conductivity Determination

The instrument used is a C-Therm TCi Thermal Conductivity Analyzer, and the test method is developed based on the standard test method for measurement of thermal effusivity of fabrics using a modified transient plane source (MTPS) instrument (ASTM D7984-16). Data collected includes thermal conductivity, k (W/mK), effusivity, e (W√s/m2K), ambient temperature tested at (° C.) and the change in temperature of the sample during testing, ΔT. The K value vs ambient temperature is reported to describe the thermal conductivity of microgel coatings in different applications.

### Hydroxyl Value Determination

Hydroxyl value (OHv) of the polyols, also known as hydroxyl number, can be determined by acetylating the polyol with pyridine and acetic anhydride and then titrating the excess anhydride with a standard KOH solution and measuring the difference between a blank solution and one containing the polyol. The OHv is the weight of KOH in milligrams that will neutralize the acetic anhydride capable of reacting by acetylation with one gram of the polyol.

### Microgel Median Volume-Weighted Particle Size Determination

The median volume-weighted particle size of the microgel is measured using an Accusizer 780A, made by Particle Sizing Systems, Santa Barbara Calif., or equivalent. The instrument is calibrated from 0 to 300 mu.m (micrometer or micron) using particle size standards (as available from Duke/Thermo-Fisher-Scientific Inc., Waltham, Mass., USA). Samples for particle size evaluation are prepared by diluting about 1 g of microgel slurry in about 5 g of de-ionized water and further diluting about 1 g of this solution in about 25 g of water. About 1 g of the most dilute sample is added to the Accusizer and the testing initiated using the autodilution feature. The Accusizer should be reading in excess of 9200 counts/second. If the counts are less than 9200 additional sample should be added. Dilute the test sample until 9200 counts/second and then the evaluation should be initiated. After 2 minutes of testing the Accusizer will display the results, including the median volume-weighted particle size.

Particle sizes stated herein on a volume weighted basis are to be understood as median volume weighted particle sizes, ascertainable by the above procedure.

### Example 1

### Preparing Aqueous Polyurethane Microgel Slurry

A water phase preparation is begun by mixing 2 grams of sodium laureth sulfate to 200 grams of water at room temperature until homogeneous. The oil phase preparation is begun by adding 40 grams of HYPERLAST™ LP 5613 isocyanate to 160 grams of HYPERLAST™ LU 1081 polyol in 5 min and mixing them at room temperature until homogeneous, using a Caframo BDC6015 mixer at 300 rpm. The water phase is added to the oil phase and the mixing speed is increased to 750 rpm over 15-30 minutes to form a stable emulsion. Agitation continues at least 24 hours to allow the completed reaction to form polyurethane microgel. The final product is a stable aqueous polyurethane microgel slurry with 50% weight ratio.

### Example 2

### Characterization of Polyurethane Microgel

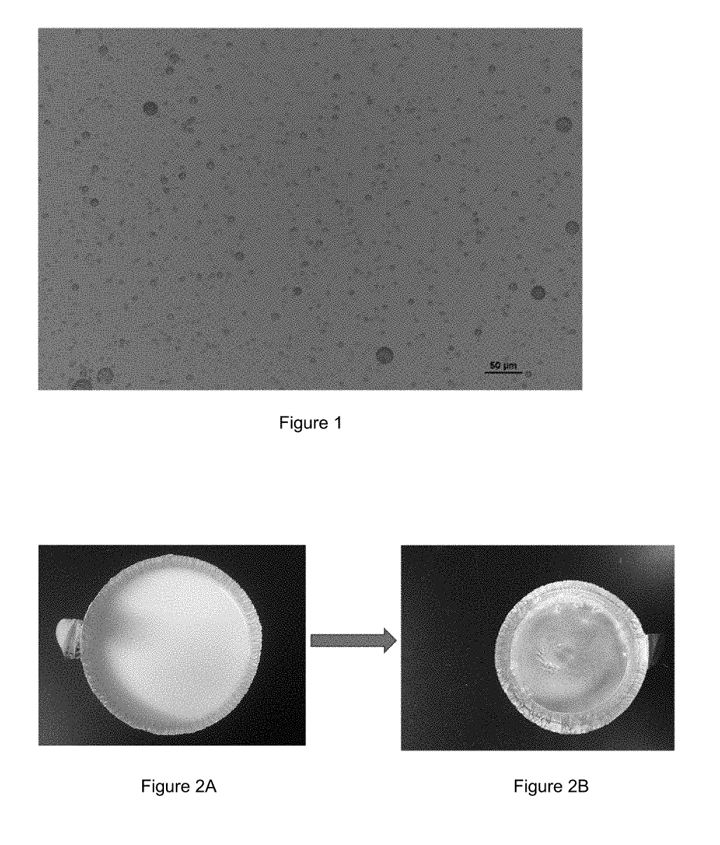

The size of the microgel of Example 1 is measured by a Model 780 AccuSizer (Particle Sizing Systems, Inc.), and the median size of the microgel is 9 μm based on volume number ratio. The microscope picture, taken by a Nikon Eclipse Ci-L microscope, shown in FIG. 1, shows the final polyurethane particles, which are micrometer size and well dispersed in the aqueous phase.

The final microgel dispersion is a white, chemically stable slurry (FIG. 2B). 5 grams of this aqueous polyurethane microgel was poured into an aluminum dish and then dried in an oven between 50° C. and 60° C. for 24 hours, turning the aqueous microgel into a transparent film (FIG. 2B).

### Example 3

### Applying Polyurethane Microgel on Foam

Coating Formula

| Components | Materials | Grams |
|---|---|---|
| Sample 1 | Microgel according to | 45 |
| | Example 1 | |
| Impranil ™ DLP-R | Binder | 5 |
| Acrysol ™ RM-12W | Rheology Modifier | 0.8 |

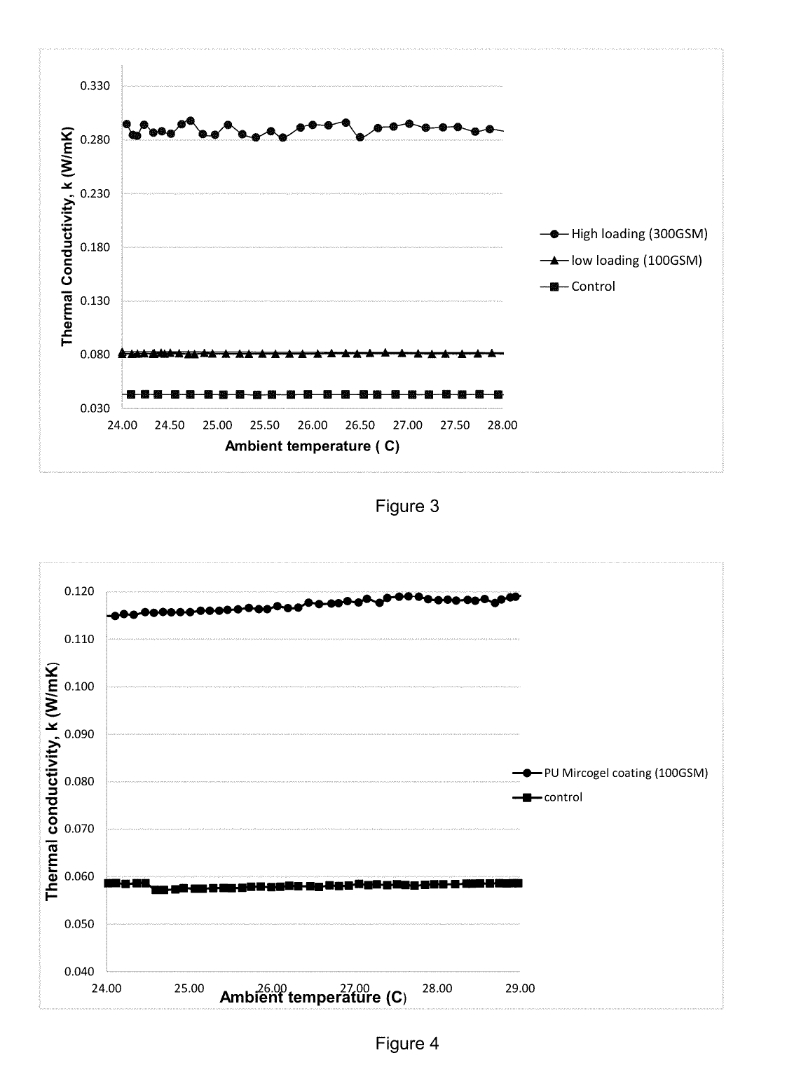

An 8 cm×8 cm Sinomax polyurethane foam was used as a model to evaluate the polyurethane microgel coating. The coating is created by mixing 45 grams of the polyurethane microgel with 5 grams of Impranil™ DLP-R (Covestro, 50% weight ratio in aqueous base) until homogeneous. Then about 0.8 grams of Acrysol™ RM-12W (Dow Chemical Company Corp. 19% weight ratio in aqueous base) was added to adjust the viscosity of the coating slurry to about 1500-2000 cps. The coating slurry was loaded into a spray gun, and sprayed on the foam. the sample was put into an oven between 110° C. and 137° C. for a drying period of 15 to 20 minutes. The final dried coating GSM (grams per square meter) is about 100 (low loading), and 300 (high loading). FIG. 3 shows the curves of K value versus ambient temperature to describe the thermal conductivity of the microgel coating. the results show that the microgel significantly increases the thermal conductivity with the K value increasing from 0.04 W/mK (Control, un-treated) to 0.08 W/mK at low loading up to 0.28 W/mK and greater at high loading at all ambient temperatures.

### Example 4

### Applying Polyurethane Microgel on Fabric

A 20 cm×20 cm polyester fabric (Oberlin Filter CO.) was used as a model to evaluate the application of microgel on fabric. The coating and drying process is the same as for Example 3. The final dried coating GSM is about 100. FIG. 4 shows the curves of K value versus ambient temperature which describes the thermal conductivity of gel film on fabric. The results show that the polyurethane microgel coating again significantly increases the thermal conductivity with the K value increase from 0.06 W/mK (Control) to 0.11-0.12 W/mK for the microgel coated sample at ambient temperatures.

### Example 5

### Applying Polyurethane Microgel with Water-Based Phase Change Encapsulation Product (EnFinit® Phase Change Material (PCM))

Coating Formula

| Components | Materials | Grams |
|---|---|---|
| Sample 1 | Microgel, | 25 |
| | according to Example 1 | |
| EnFinit ® PCM28 | Encapsulated phase | 20 |
| | change microcapsules | |
| Impranil ™ DLP-R | Binder | 5 |
| Acrysol ™ RM-12W | Rheology Modifier | 0.8 |

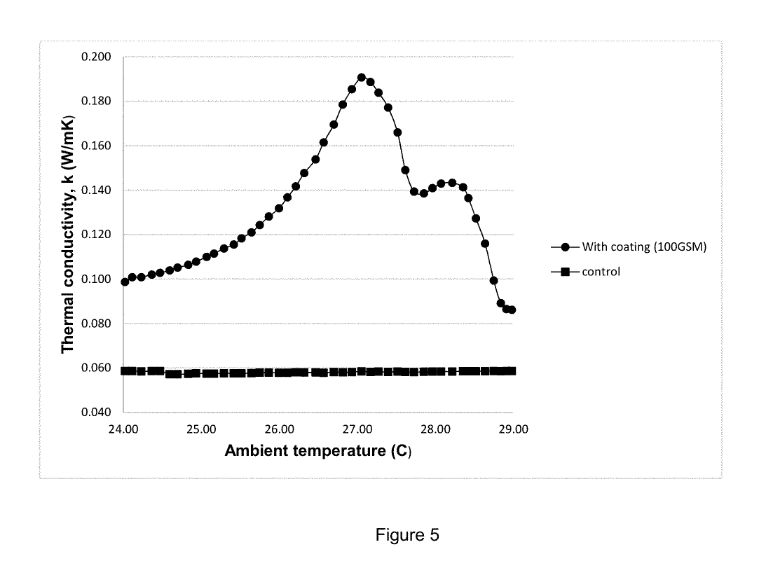

The coating is created by mixing 25 grams of the polyurethane microgel, 20 grams of the EnFinit® PCM28 slurry (Encapsys. 50% weight ratio in aqueous solution), and 5 grams of Impranil™ DLP-R, until homogeneous. About 0.8 grams of Acrysol™ RM-12 is added to adjust the viscosity of the coating slurry to about 1500-2000 cps. The fabric coating and drying process is the same as for Example 4. The final dried coating GSM is about 100. It shows that polyurethane microgel is easily incorporated with water-based encapsulated phase change materials. FIG. 5 shows the curves of K value versus ambient temperature to describe the thermal conductivity of the coating on fabric. The result shows that microgel also significantly increases the thermal conductivity with the K value from 0.06 W/mK (Control) to 0.11-0.12 W/mK for the microgel coated sample at ambient temperatures. It also shows that the microgel coating works with encapsulated phase change materials to increase K value constantly up to 0.19 W/mK as the temperature increases further, until reaching the melting point of the encapsulated phase change materials at 27 to 28° C.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. All references, including publications, patent applications, and patents, cited herein are hereby incorporated by reference. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims.

What is claimed is:

1. A method of forming a stable aqueous polyurethane microgel dispersion comprising:
i) preparing an oil phase comprising a gel-forming polyol and an isocyanate in approximately stoichiometric proportion by blending the polyol and isocyanate for a time, less than the gel time of the polyol and isocyanate blend, thereby forming a homogeneous flowable liquid mixture;
ii) providing a water phase comprising a surfactant dispersed in water;
iii) combining the water phase with the oil phase flowable liquid mixture and subjecting the combined water and oil phases to high shear agitation to form an aqueous emulsion of micro-size droplets of the oil phase flowable mixture in water; and
iv) agitating the emulsion for a time sufficient for the micro-size droplets to polymerize, forming a stable aqueous suspension of solid polyurethane micro-size gel particles.

2. The method according to claim 1 wherein the polyol is a hydrophobic, water-dispersible, or slightly water-soluble polyol having a viscosity less than 1000 cps.

3. The method according to claim 1 wherein the polyol is a di- or polyol selected from the group consisting of polyalkylene ether polyol, polyether polyol, polyester polyol, polyhydroxy polyester amide and polyoxyalkylene glycol, and having a hydroxy value between 10 and 2000.

4. The method according to claim 1 wherein the polyol is a di- or polyol selected from the group consisting of ethylene glycol, propylene glycol, 1,4-butane diol, 1,6-heane diol, 1,2-cyclohexane diol, cyclohexane dimethanol, trimethylol propane, glycerol, penta erythritol and oxyalkylated glycerol.

5. The method according to claim 1 wherein the isocyanate is a di- or polyisocyanate and is selected form aliphatic polyisocyanate, cycloaliphatic polyisocyanate, araliphatic polyisocyanate, aromatic polyisocyanate and heterocyclic polyisocyanate.

6. The method according to claim 1 wherein the polyol and isocyanate have a gel time and are blended in step i) for a period of time, shorter than the gel time.

7. The method according to claim 1 wherein the isocyanate is methylene diphenyl diisocyanate or a prepolymer thereof.

8. The method according to claim 1 wherein the isocyanate has a viscosity of less than 3000 cps.

9. The method according to claim 7 wherein the sulfate is sodium laureth sulfate.

10. The method according to claim 1 wherein the surfactant is selected from the group consisting of: potassium laureth sulfate, sodium laureth sulfate, sodium lauroyl methyl isethionate, sodium lauryl isethionate, sodium cocoyl isethionate, sodium laureth-5 carboxylate, lauryl ether carboxylic acid, ammonium lauryl sulfate, sodium lauryl sulfate, potassium lauryl sulfate, potassium laureth sulfate, ammonium cocoyl sulfate, ammonium lauroyl sulfate, sodium cocoyl sulfate, sodium lauroyl sulfate, potassium cocoyl sulfate, sodium tridecyl benzene sulfonate, sodium dodecyl benzene sulfonate, sodium C14-16 olefin sulfonate, sodium caprylic sulfate, sodium capric sulfate, sodium oleic sulfate, sodium stearyl sulfate, sodium myreth sulfate, sodium dodecanesulfate, and sodium monododecyl sulfate.

11. The method according to claim 1 wherein the polyol and isocyanate blend has a gel time of 60 minutes or less, and the blending of step i) is shorter than said gel time, so that no significant polyurethane gel or prepolymer formation occurs during the oil phase preparation step i).

12. The method according to claim 1 wherein the polyol and isocyanate blend is substantially reacted by in-situ polymerization after the emulsion is formed and wherein the aqueous suspension of micro-size polyurethane gel particles has substantially no free isocyanate monomer.

13. The method according to claim 1 wherein the particle size of the micro-size polyurethane gel particles on average is less than 1000 microns on a volume weighted basis.

14. The method according to claim 1 wherein a benefit agent is added in addition.

15. The method according to claim 14 wherein the benefit agent is selected from the group consisting of fragrance, a phase change material, a thermal conductivity agent, a binder, a softener, a pharmaceutical agent, a biocide, a fertilizer, an herbicide or a pesticide.

16. The method according to claim 14 wherein the benefit agent is a microencapsulated material.

17. The method according to claim 1 wherein a phase change material is added after step iv).

18. The method according to claim 17 wherein the phase change material is encapsulated.

19. The method of 17 comprising the additional step of applying the stable aqueous microgel onto a substrate and drying the applied aqueous microgel wherein the particulates of polyurethane gel domains coalesce thereby forming a substantially transparent coating on the substrate.

20. The method of claim 19 wherein the transparent coating is a temperature moderating coating and the substrate is selected from a foam, a fabric, a textile. or a nonwoven.

21. The method of claim 19 wherein the transparent coating is a cooling gel coating.

22. The method of claim 19 comprising in addition the step of drying the applied microgel.
